(19) United States
(12) Patent Application Publication
(10) Pub. No.: US 2024/0251337 A1
(43) Pub. Date: Jul. 25, 2024

(54) WIRELESS COMMUNICATION APPARATUS, WIRELESS COMMUNICATION SYSTEM, AND WIRELESS COMMUNICATION METHOD

(71) Applicant: FUJITSU LIMITED, Kawasaki-shi Kanagawa (JP)

(72) Inventors: Yoshiaki OHTA, Yokohama (JP); Shinichiro AIKAWA, Yokohama (JP); Yoshihiro KAWASAKI, Kawasaki (JP)

(73) Assignee: FUJITSU LIMITED, Kawasaki-shi Kanagawa (JP)

(21) Appl. No.: 18/627,862

(22) Filed: Apr. 5, 2024

Related U.S. Application Data
(63) Continuation of application No. PCT/JP2021/038670, filed on Oct. 19, 2021.

(51) Int. Cl. H04W 48/16

(52) U.S. Cl. CPC H04W 48/16

(57) ABSTRACT

A wireless communication apparatus includes processor circuitry configured to control to perform data communication when communication is implemented with another wireless communication apparatus, the data communication selectively using a multiple-cell group, the multiple-cell group being selected when communication with the other wireless communication apparatus in a non-communication mode is established and being able to perform data communication allowed even in the non-communication mode.

### CROSS-REFERENCE TO RELATED APPLICATION

This application is a continuation of International Application No. PCT/JP2021/038670, filed on Oct. 19, 2021, the entire contents of which are incorporated herein by reference.

### FIELD

The embodiments discussed herein are related to a wireless communication apparatus, a wireless communication system, and a wireless communication method.

### BACKGROUND

In general, radio resource control (RRC) layer processing is performed in a wireless communication system. Configuration, modification, and release of the connection between a base station apparatus and a terminal apparatus are performed in the RRC layer processing, for example. For example, Long Term Evolution (LTE) or LTE-Advanced (LTE-A), a standard technology for 4G, has defined RRC connected mode (RRC_CONNECTED) and RRC idle mode (RRC_IDLE) as the RRC layer state. The RRC connected mode is, for example, a mode in which data communication can be implemented between a base station apparatus and a terminal apparatus. The RRC idle mode is, for example, a mode in which no data communication is implemented between the base station apparatus and the terminal apparatus, and the terminal apparatus is in a power-saving state.

The fifth generation mobile communication (5G or New Radio (NR)) has defined RRC inactive mode (RRC_INACTIVE) in addition to the RRC connected mode and RRC idle mode. The RRC inactive mode is a low-power consumption mode equivalent to the RRC idle mode, and allows a quick transition to the RRC connected mode during data transmission. In the RRC inactive mode, a context of a terminal apparatus (“UE context”) is maintained in the base station apparatus. The UE context is identification information that identifies information on the terminal apparatus, such as a location, communication capability, and various parameters thereof. Thus, since the UE context is held in the base station apparatus, it is assumed by a core network that the terminal apparatus is being connected to the base station apparatus even in the RRC inactive mode. As a result, when the terminal apparatus returns from the RRC inactive mode to the RRC connected mode, signal transmission and reception between the base station apparatus and the core network are omitted, resulting in a quick transition to the RRC connected mode.

The RRC inactive mode is a mode in which no data communication is implemented between the base station apparatus and the terminal apparatus, except for data communication that is needed to implement or maintain communication. In addition, the RRC idle mode is a mode in which the terminal apparatus is in a power-saving state, and no data communication is implemented between the base station apparatus and the terminal apparatus. On the other hand, it has recently been examined to achieve the transmission of predetermined data (for example, small data) even during these non-communication modes. In other words, for example, it can be considered that small data, such as failure information of the terminal apparatus and measurements by sensors, is transmitted from the terminal apparatus to the base station apparatus during the RRC inactive mode. The related technologies are described, for example, in: Japanese Laid-open Patent Publication No. 2020-048100; International Publication Pamphlet No. WO2020/196780; International Publication Pamphlet No. WO2019/065814; and in the following non-patent documents:
3GPP TS36.133 V17.1.0 (2021-03);
3GPP TS36.211 V16.5.0 (2021-03);
3GPP TS36.212 V16.5.0 (2021-03);
3GPP TS36.213 V16.5.0 (2021-03);
3GPP TS36.214 V16.2.0 (2021-03);
3GPP TS36.300 V16.5.0 (2021-03);
3GPP TS36.321 V16.4.0 (2021-03);
3GPP TS36.322 V16.0.0 (2020-07);
3GPP TS36.323 V16.3.0 (2020-12);
3GPP TS36.331 V16.4.0 (2021-03);
3GPP TS36.413 V16.5.0 (2021-04);
3GPP TS36.423 V16.5.0 (2021-04);
3GPP TS36.425 V16.0.0 (2020-07);
3GPP TS37.324 V16.2.0 (2020-09);
3GPP TS37.340 V16.5.0 (2021-03);
3GPP TS38.201 V16.0.0 (2019-12);
3GPP TS38.202 V16.2.0 (2020-09);
3GPP TS38.211 V16.5.0 (2021-03);
3GPP TS38.212 V16.5.0 (2021-03);
3GPP TS38.213 V16.5.0 (2021-03);
3GPP TS38.214 V16.5.0 (2021-03);
3GPP TS38.215 V16.4.0 (2020-12);
3GPP TS38.300 V16.5.0 (2021-03);
3GPP TS38.321 V16.4.0 (2021-03);
3GPP TS38.322 V16.2.0 (2020-12);
3GPP TS38.323 V16.3.0 (2021-03);
3GPP TS38.331 V16.4.1 (2021-03);
3GPP TS38.401 V16.5.0 (2021-04);
3GPP TS38.410 V16.3.0 (2020-09);
3GPP TS38.413 V16.5.0 (2021-04);
3GPP TS38.420 V16.0.0 (2020-07);
3GPP TS38.423 V16.5.0 (2021-04);
3GPP TS38.470 V16.4.0 (2021-04);
3GPP TS38.473 V16.5.0 (2021-04);
3GPP TR38.801 V14.0.0 (2017-03);
3GPP TR38.802 V14.2.0 (2017-09);
3GPP TR38.803 V14.2.0 (2017-09);
3GPP TR38.804 V14.0.0 (2017-03);
3GPP TR38.900 V15.0.0 (2018-06);
3GPP TR38.912 V16.0.0 (2020-07);
3GPP TR38.913 V16.0.0 (2020-07).

### SUMMARY

According to an aspect of an embodiment, a wireless communication apparatus includes a processor configured to control to perform data communication when communication is performed with another wireless communication apparatus, the data communication selectively using a multiple-cell group, the multiple-cell group being selected when communication with the other wireless communication apparatus in a non-communication mode is established and being able to perform data communication allowed even in the non-communication mode.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating a configuration example of a wireless communication system according to a first embodiment;

FIG. 2 is a block diagram illustrating a configuration of a base station apparatus;

FIG. 3 is a block diagram illustrating a configuration of a terminal apparatus;

FIG. 4 is a sequence diagram illustrating a cell selection method according to a second embodiment;

FIG. 5 is a sequence diagram illustrating a small data transmission method;

FIG. 6 is a sequence diagram illustrating another small data transmission method;

FIG. 7 is a sequence diagram illustrating a cell selection method according to a third embodiment; and

FIG. 8 is a sequence diagram illustrating a cell selection method according to another embodiment.

### DESCRIPTION OF EMBODIMENTS

However, when the radio quality between the terminal apparatus and the base station apparatus degrades during a non-communication mode, for example, data communication failures occur, resulting in the problem that performing of continuous data communication becomes difficult. In other words, for example, when a data communication failure occurs during the RRC inactive mode, the terminal apparatus starts a predetermined timer and transitions to the RRC idle mode when the timer expires. The terminal apparatus then selects a cell with good radio quality again after transitioning to the RRC idle mode.

Thus, when the data communication failure occurs during the RRC inactive mode, the transition to the RRC idle mode and the cell reselection are carried out, making data such as small data difficult to be continuously transmitted.

Preferred embodiments will be explained with reference to accompanying drawings. The present disclosure is not limited to the embodiments.

### (a) First Embodiment

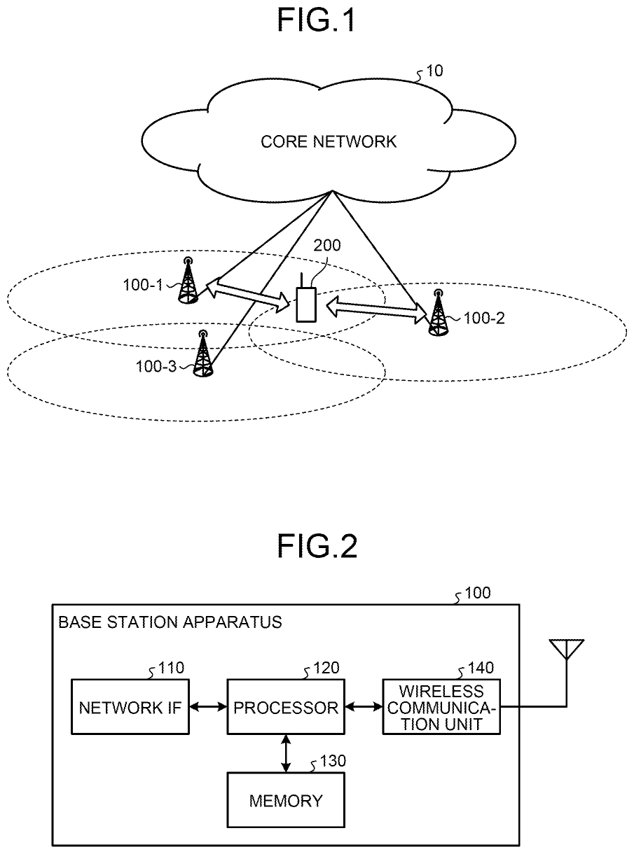

FIG. 1 is diagram illustrating a configuration example of a wireless communication system according to a first embodiment. The wireless communication system illustrated in FIG. 1 includes a plurality of first wireless communication apparatuses 100-1 to 100-3, which are connected to a core network 10, and a second wireless communication apparatus 200.

Each of the first wireless communication apparatuses 100-1 to 100-3 is connected to the core network 10 and can wirelessly communicate with the second wireless communication apparatus 200 located in cells. In FIG. 1, a cell formed by each of the first wireless communication apparatuses 100-1 to 100-3 is indicated by dashed line.

Each of the first wireless communication apparatuses 100-1 to 100-3 includes a control unit that is able to control to perform data communication in a case in which communication is performed with the second wireless communication apparatus 200, the data communication selectively using a multiple-cell group, the multiple-cell group being selected when communication with the second wireless communication apparatus 200 during a non-communication mode is established and being able to perform data communication allowed even during the non-communication mode. In other words, the first wireless communication apparatuses 100-1 to 100-3 are selected, depending on the radio quality of wireless communication with the second wireless communication apparatus 200, as wireless communication apparatuses serving as communication counterparts that form a plurality of cells used for data communication by the second wireless communication apparatus 200 during the non-communication mode. That is, while the second wireless communication apparatus 200 is in the non-communication mode, a plurality of the communication counterparts for the second wireless communication apparatus 200 are selected from the first wireless communication apparatuses 100-1 to 100-3. In a case in which the second wireless communication apparatus 200 performs data communication during the non-communication mode, the second wireless communication apparatus 200 carries out data communication with other selected first wireless communication apparatuses when the data communication fails with one selected first wireless communication apparatus. Therefore, the second wireless communication apparatus 200 can perform continuous data communication even though the data communication fails with the one first wireless communication apparatus during the non-communication mode.

When located in cells, the second wireless communication apparatus 200 can wirelessly communicate with the first wireless communication apparatuses 100-1 to 100-3 that form the cells. The second wireless communication apparatus 200 can operate by switching between a communication mode such as RRC connected mode and a non-communication mode such as RRC inactive mode, for example.

The second wireless communication apparatus 200 includes a control unit that is able to control to perform data communication in a case in which communication is carried out with the first wireless communication apparatuses 100-1 to 100-3, under control from the first wireless communication apparatuses 100-1 to 100-3 serving as the communication counterparts, the data communication selectively using a multiple-cell group, the multiple-cell group being selected when communication with the first wireless communication apparatuses 100-1 to 100-3 is established during a non-communication mode and being able to perform data communication allowed even during the non-communication mode. In other words, the second wireless communication apparatus 200 selectively performs data communication with a plurality of the wireless communication apparatuses selected from the first wireless communication apparatuses 100-1 to 100-3.

The second wireless communication apparatus 200 is configured, during the non-communication mode, in advance so that the wireless communication apparatuses selected from the first wireless communication apparatuses 100-1 to 100-3 serve as the communication counterparts. Therefore, when the data communication fails with the one selected first wireless communication apparatus during the non-communication mode, the second wireless communication apparatus 200 can perform data communication with the other selected first wireless communication apparatuses and can continue to perform the data communication.

As described above, according to the present embodiment, since the first wireless communication apparatuses are selected as communication counterparts for the second wireless communication apparatus during the non-communication mode, the second wireless communication apparatus performs data communication with the other first wireless communication apparatuses even though the data communication fails with the one first wireless communication apparatus. Thus, the continuous data communication can be performed during the non-communication mode.

### (b) Second Embodiment

In a second embodiment, it will now be described as to a case in which a terminal apparatus sets up calls with a plurality of base station apparatuses during the non-communication mode. The description of a configuration of the wireless communication system according to the second embodiment will not be repeated because the configuration thereof is the same as that in the first embodiment (FIG. 1). The first embodiment is appropriately specified to describe the second embodiment, and the second embodiment can be implemented in combination with the first embodiment to the extent that those do not contradict with each other.

FIG. 2 is a block diagram illustrating a configuration of a base station apparatus 100 according to the second embodiment. The base station apparatus 100 has the same configuration as those of base station apparatuses 100-1 to 100-3. The base station apparatus 100 illustrated in FIG. 2 includes a network interface (hereinafter abbreviated as “network IF”) 110, a processor 120, a memory 130, and a wireless communication unit 140.

The network IF 110 is connected to the core network 10 over wireline, and transmits and receives signals to and from apparatus such as access and mobility management function (AMF), which constitutes the core network 10, for example. The network IF 110 also includes an interface to connect to another base station apparatus, such as an X2 interface, for example, and transmits and receives signals to and from the other base station apparatus.

The processor 120 includes, for example, a central processing unit (CPU), a field programmable gate array (FPGA), a digital signal processor (DSP), or the like, and is a control unit that performs overall control on the whole of the base station apparatus 100. In addition, the processor 120 controls, in a case in which communication is carried out with a terminal apparatus 200, performing data communication selectively using a multiple-cell group, the multiple-cell group being selected, for example, when communication with the terminal apparatus 200 is established during a non-communication mode such as RRC inactive mode and being able to perform data communication during the non-communication mode. In other words, when data communication with one selected base station fails, the processor 120 performs a control to cause the terminal apparatus 200 in the non-communication mode to perform data communication with other selected base stations.

The memory 130 includes, for example, a random access memory (RAM), a read only memory (ROM), or the like and stores information used for processing executed by the processor 120.

The wireless communication unit 140 performs wireless communication with a correspondent terminal apparatus 200. The wireless communication unit 140 transmits identification information on a UE context generated by the processor 120, for example, to the terminal apparatus 200. The wireless communication unit 140 also receives data transmitted from the terminal apparatus 200. The wireless communication unit 140 can perform the predetermined communication with the terminal apparatus 200 even though the correspondent terminal apparatus 200 is in the non-communication mode.

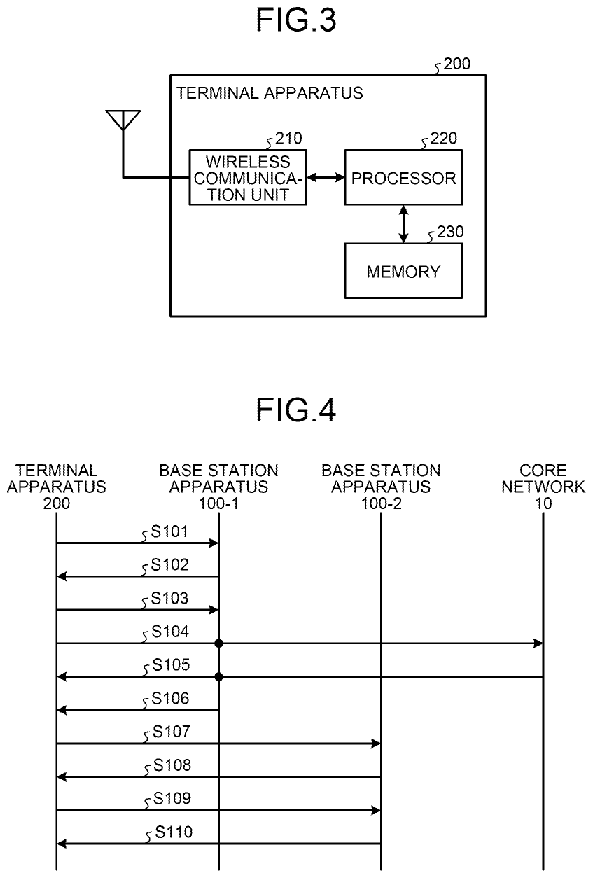

FIG. 3 is a block diagram illustrating a configuration of the terminal apparatus 200 according to the second embodiment. The terminal apparatus 200 illustrated in FIG. 3 includes a wireless communication unit 210, a processor 220, and a memory 230.

The wireless communication unit 210 performs wireless communication with the correspondent base station apparatus 100. The wireless communication unit 210 transmits and receives various signals to and from the base station apparatus 100 in order to cause the terminal apparatus 200 to switch between the communication mode and non-communication mode. For example, the wireless communication unit 210 receives identification information on the UE context from the base station apparatus 100 when the terminal apparatus 200 establishes communication with the base station apparatus 100. The wireless communication unit 210 can perform the predetermined communication allowed by the base station apparatus 100 even though the terminal apparatus 200 is in the non-communication mode.

The processor 220 is a control unit that includes, for example, a CPU, a FPGA, a DSP, or the like and performs overall control on the whole of the terminal apparatus 200. In addition, under control from the base station apparatus 100 serving as a communication counterpart, the processor 220 controls to perform data communication selectively using a multiple-cell group, the multiple-cell group being selected when communication with the base station apparatus 100 is established during the non-communication mode and being able to perform data communication allowed even during the non-communication mode. In other words, when data communication with one selected base station fails during the non-communication mode, the processor 220 performs a control to perform data communication with other selected base stations under control from the base station apparatus 100.

The memory 230 includes, for example, a RAM, a ROM, or the like and stores information used for processing executed by the processor 220.

Next, a cell selection method in the wireless communication system configured as described above will be explained with reference to FIG. 4. In the following description, the wireless communication system includes base station apparatuses 100-1 and 100-2 each of which has the same configuration as that of the base station apparatus 100.

The terminal apparatus 200 measures the signal strength from surrounding base station apparatuses including the base station apparatuses 100-1 and 100-2 during the non-communication mode and selects a plurality of base stations which can be communication counterparts. Here, for example, the terminal apparatus 200 may select the base station apparatus 100-1 with the highest signal strength as the primary base station to communicate with the first priority, and select the base station apparatus 100-2 with the second highest signal strength as the secondary base station to communicate with the second priority.

The terminal apparatus 200 then transmits an access stratum (AS) message (hereinafter referred to as “AS message”) requesting a connection to establish communication with the base station apparatus 100-1 which is the primary base station, during the non-communication mode (step S101). Examples of this AS message include an RRC connection request (Connection Request), RRC connection resume request (Connection Resume Request) or the like, for example.

Regarding this AS message, an AS message for predetermined configurations is transmitted from the base station apparatus 100-1 to the terminal apparatus 200 (step S102), and an AS message to notify the completion of a connection from the terminal apparatus 200 to the base station apparatus 100-1 is transmitted (step S103). The AS message to notify the completion of the connection includes information indicating that the base station apparatus 100-1 is the primary base station. In other words, the terminal apparatus 200 can notify the base station apparatus 100-1 that the selection on the base station apparatus 100-1 as the primary base station has been made. Upon receiving this notification, the base station apparatus 100-1 can grasp that the base station apparatus 100-1 is the primary base station and serves as the base station that performs a control to cause the terminal apparatus 200 to perform data communication selectively using a plurality of cells. The information indicating that the base station apparatus 100-1 is the primary base station may be included in the AS message requesting the connection at the step S101.

When the connection between the terminal apparatus 200 and the base station apparatus 100-1 is established, a non-access stratum (NAS) message (hereinafter referred to as “NAS message”) for a registration (for example, a location registration) is transmitted from the terminal apparatus 200 to the core network 10 via the base station apparatus 100-1 (step S104). When the terminal apparatus 200 is registered in the core network 10, a NAS message indicating that the registration has been accepted is transmitted from the core network 10 to the terminal apparatus 200 via the base station apparatus 100-1 (step S105).

In addition, in the base station apparatus 100-1, a UE context regarding the terminal apparatus 200 is generated. Temporary identification information including the identification information of the terminal apparatus 200 and the identification information of the base station apparatus 100-1 is then generated as identification information on the UE context. An inactive-radio network temporary identifier (I-RNTI) can be used as this temporary identification information, for example. The I-RNTI is 40 bits of identification information that enables simultaneous identification on the terminal apparatus and the base station apparatus. Since the I-RNTI is 40 bits of identification information, the number of identifiable terminal apparatuses decreases while the number of identifiable base station apparatuses increases when the number of bits assigned to the identification information of the base station apparatus is increased. In addition, the number of identifiable terminal apparatuses increases while the number of identifiable base station apparatuses decreases when the number of bits assigned to the identification information of the base station apparatus is decreased. As identification information on the UE context, any information that enables identification on the UE context can be used in addition to the I-RNTI.

The base station apparatus 100-1 holds the generated UE context and notifies the terminal apparatus 200 of the identification information on the UE context, for example, by an AS message to release the connection (step S106). Upon receiving this notification, the terminal apparatus 200 holds the identification information on the UE context and releases the connection with the base station apparatus 100-1. Accordingly, the terminal apparatus 200 transitions to the non-communication mode, such as RRC inactive mode, for example.

The terminal apparatus 200 then transmits an AS message requesting a connection to establish communication with the base station apparatus 100-2 serving as the secondary base station (step S107). Regarding this AS message, an AS message for predetermined configurations is transmitted from the base station apparatus 100-2 to the terminal apparatus 200 (step S108), and an AS message to notify the completion of a connection from the terminal apparatus 200 to the base station apparatus 100-2 is transmitted (step S109). The AS message to notify the completion of the connection includes information indicating that the base station apparatus 100-2 is the secondary base station. In other words, the terminal apparatus 200 can notify the base station apparatus 100-2 that the selection on the base station apparatus 100-2 as the secondary base station has been made. Upon receiving this notification, the base station apparatus 100-2 grasps that the base station apparatus 100-2 is the secondary base station. The information indicating that the base station apparatus 100-2 is the secondary base station may be included in the AS message requesting the connection at the step S107.

Here, the terminal apparatus 200 has already completed the registration to the core network 10 via the base station apparatus 100-1 serving as the primary base station. Therefore, when the terminal apparatus 200 establishes the connection with the base station apparatus 100-2, the registration to the core network 10 is omitted. Therefore, no NAS message is transmitted or received between the terminal apparatus 200 and the core network 10, and the UE context related to the terminal apparatus 200 is generated in the base station apparatus 100-2. Temporary identification information including the identification information of the terminal apparatus 200 and the identification information of the base station apparatus 100-2 is then generated as identification information on the UE context. As this temporary identification information, for example, I-RNTI can be used similarly to the identification information generated by the base station apparatus 100-1.

The base station apparatus 100-2 holds the generated UE context and notifies the terminal apparatus 200 of the identification information on the UE context, for example, by an AS message to release the connection (step S110). Upon receiving this notification, the terminal apparatus 200 holds the identification information on the UE context and releases the connection with the base station apparatus 100-2. At this time, the terminal apparatus 200 transitions to the non-communication mode, such as RRC inactive mode, for example.

In this way, during the non-communication mode, the terminal apparatus 200 selects the primary and secondary base stations according to the signal strength, requests the connection to each of the primary and secondary base stations, and receives the notification of the identification information on the UE context from each of the primary and secondary base stations. Therefore, the terminal apparatus 200 can selectively perform data communication with the base stations even during the non-communication mode. For example, when the data communication with the primary base station fails, the terminal apparatus 200 can perform the data communication with the secondary base station.

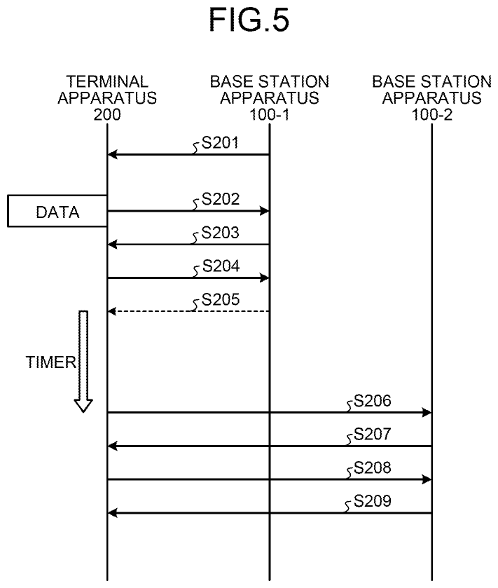

FIG. 5 is a sequence diagram illustrating a small data transmission method for the terminal apparatus 200 during the non-communication mode.

When receiving an AS message to release the connection from, for example, the base station apparatus 100-1 during the communication (step S201), the terminal apparatus 200 releases the connection with the base station apparatus 100-1 and transitions to the RRC inactive mode. Examples of this AS message include RRC connection release (Connection Release) and the like.

When small data is generated during the RRC inactive mode, the terminal apparatus 200 transmits small data to the base station apparatus 100-1 serving as the primary base station, which has already been selected, by the random access method. Specifically, the terminal apparatus 200 transmits a

Message 1 (Msg1) including a random access preamble to the base station apparatus 100-1 (step S202) and receives a Message 2(Msg2) including a random access response from the base station apparatus 100-1 (step S203). Then, the terminal apparatus 200 transmits a Message 3 (Msg3) including the identification information on the UE context notified by the base station apparatus 100-1 to the base station apparatus 100-1 (step S204), and receives a Message 4 (Msg4), which is a response to the Message 3, from the base station apparatus 100-1 (Step S205).

The terminal apparatus 200 can transmit the small data together with the Message 1 or the Message 3 described above to the base station apparatus 100-1. Here, for example, when the radio quality between the terminal apparatus 200 and the base station apparatus 100-1 is degraded, and the small data transmission fails, the above-described steps S202 to S205 are not completed successfully. That is, the terminal apparatus 200 may receive no Message 4 at the step S205, for example.

In such a case, the terminal apparatus 200 starts a predetermined timer and waits for a response from the base station apparatus 100-1 during the timer operation. When the timer expires, the terminal apparatus 200 switches the communication partner to the base station apparatus 100-2 serving as the secondary base station, which has already been selected, and transmits the small data to the base station apparatus 100-2 by the random access method. For example, the timer is T319. Specifically, the terminal apparatus 200 transmits a Message 1 (Msg1) including a random access preamble to the base station apparatus 100-2 (step S206) and receives a Message 2 (Msg2) including a random access response from the base station apparatus 100-2 (step S207). Then, the terminal apparatus 200 transmits a Message 3 (Msg3) including the identification information on the UE context notified by the base station apparatus 100-2 to the base station apparatus 100-2 (step S208), and receives a Message 4 (Msg4), which is a response to the Message 3, from the base station apparatus 100-2 (Step S209).

In this way, since the terminal apparatus 200 transmits the small data to the primary and secondary base stations, which have already been selected during the non-communication mode, selectively as the communication counterparts, the terminal apparatus 200 can transmit the small data to the secondary base station even though the small data transmission to the primary base station fails. As a result, the continuous data communication can be achieved during the non-communication mode.

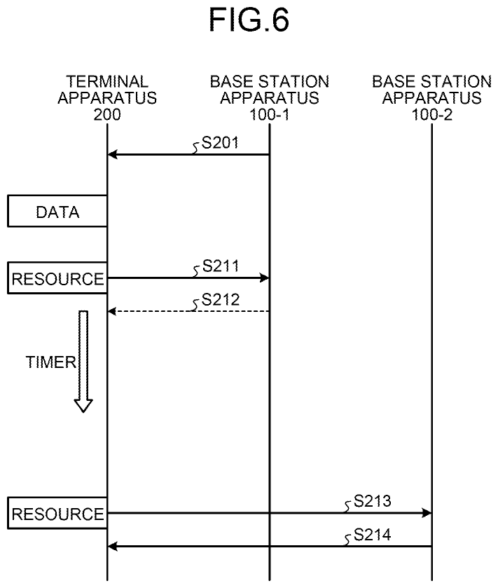

FIG. 6 is a sequence diagram illustrating another small data transmission method for the terminal apparatus 200 during the non-communication mode. In FIG. 6, the same reference numerals are given to the same components as those in FIG. 5.

When receiving an AS message to release the connection from, for example, the base station apparatus 100-1 during the communication (step S201), the terminal apparatus 200 releases the connection with the base station apparatus 100-1 and transitions to the RRC inactive mode. Examples of this AS message include RRC connection release Connection Release and the like.

When small data is generated during the RRC inactive mode, the terminal apparatus 200 transmits the small data to the base station apparatus 100-1 serving as the primary base station, which has already been selected, by a configured grant (CG) method using a wireless resource assigned to the terminal apparatus 200 in advance. Specifically, when the timing for a radio resource that has been assigned to the terminal apparatus 200 in advance by the base station apparatus 100-1 arrives, the terminal apparatus 200 transmits the small data by using this radio resource (step S211). When the base station apparatus 100-1 has successfully received the small data, the base station apparatus 100-1 transmits an acknowledgement to that effect to the terminal apparatus 200 (step S212).

Here, for example, when the radio quality between the terminal apparatus 200 and the base station apparatus 100-1 is degraded, and the small data transmission fails, the above-described steps S211 and S212 are not completed successfully. That is, the terminal apparatus 200 may not receive acknowledgement at the step S212, for example.

In such a case, the terminal apparatus 200 starts a predetermined timer and waits for a response from the base station apparatus 100-1 during the timer operation. When the timer expires, the terminal apparatus 200 switches the communication counterpart to the base station apparatus 100-2 serving as the secondary base station, which has already been selected, and transmits the small data to the base station apparatus 100-2 by the CG method. Specifically, when the timing for a radio resource that has been assigned to the terminal apparatus 200 in advance by the base station apparatus 100-2 arrives, the terminal apparatus 200 transmits the small data by using this radio resource (step S213). When the base station apparatus 100-2 has successfully received the small data, the base station apparatus 100-2 transmits an acknowledgement indicating it to the terminal apparatus 200 (step S214).

In a case in which T319 is used as a timer, the time set in T319 may be set shorter than usual to encourage switching of the communication partner, or the communication counterpart may be switched without waiting for T319 to expire. In addition, the time until the terminal apparatus 200 switches the communication counterpart may be set to a time obtained by dividing the time set in T319 by the number of selected base stations.

In this way, since the terminal apparatus 200 transmits the small data to the primary and secondary base stations, which have already been selected during the non-communication mode, selectively as the communication counterparts, the terminal apparatus 200 can transmit the small data to the secondary base station even though the small data transmission to the primary base station fails. As a result, the continuous data communication can be achieved during the non-communication mode.

As described above, according to the present embodiment, the terminal apparatus selects the primary and secondary base stations that can be the communication counterparts during the non-communication mode, and receives notification of the identification information on the UE context from the primary and secondary base stations. When transmitting data during the non-communication mode, the terminal apparatus selectively transmits the data to the primary and secondary base stations. Therefore, even though the data transmission to the primary base station fails, the terminal apparatus can transmit the data to the secondary base station, and continuous data communication can be performed during the non-communication mode.

### (c) Third Embodiment

In a third embodiment, it will now be described as to a case in which a primary base station acquires the measurement (IDLE mode measurement) of the signal strength at the terminal apparatus during the RRC idle mode to select a secondary base station. The description of a configuration of the wireless communication system according to the third embodiment will not be repeated because the configuration thereof is the same as that in the first embodiment (FIG. 1). In addition, the description of the configurations of the base station apparatus 100 and the terminal apparatus 200 according to the third embodiment will not be repeated because the configurations thereof are the same as those in the second embodiment (FIGS. 2 and 3). The third embodiment appropriately specifies the first embodiment in details, and the third embodiment can be implemented in combination with the first and second embodiments to the extent that those do not contradict with one another. Note that, the IDLE mode measurement is a radio measurement controlled by the network even though the terminal apparatus 200 is in the RRC idle mode or RRC inactive mode, and is different from a radio measurement independently carried out by the terminal apparatus 200 in the RRC idle mode or RRC inactive mode.

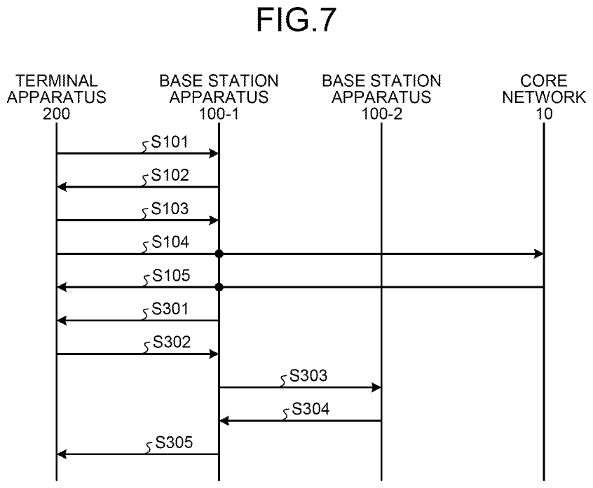

FIG. 7 is a sequence diagram illustrating the cell selection method in the wireless communication system according to the third embodiment. In FIG. 7, the same reference numerals are given to the same components as those in FIG. 4. In the following description, the wireless communication system includes base station apparatuses 100-1 and 100-2 each of which has the same configuration as that of the base station apparatus 100.

The terminal apparatus 200 measures the signal strength from surrounding base station apparatuses including the base station apparatuses 100-1 and 100-2 during the non-communication mode and selects a base station which can be a communication counterpart. Here, for example, it is assumed that the terminal apparatus 200 selects the base station apparatus 100-1 with the highest signal strength as the primary base station to communicate with the first priority.

The terminal apparatus 200 then transmits an AS message requesting a connection to establish communication with the base station apparatus 100-1 serving as the primary base station during the non-communication mode (step S101). Examples of this AS message include an RRC connection request (Connection Request), RRC connection resume request (Connection Resume Request) or the like, for example.

Regarding this AS message, an AS message for predetermined configurations is transmitted from the base station apparatus 100-1 to the terminal apparatus 200 (step S102), and an AS message to notify the completion of a connection from the terminal apparatus 200 to the base station apparatus 100-1 is transmitted (step S103). The AS message with notification of the connection completion can include information indicating that the base station apparatus 100-1 is the primary base station and flag information indicating that the terminal apparatus 200 is measuring signal strength during the RRC idle mode. In other words, the terminal apparatus 200 can notify the base station apparatus 100-1 of the selection on the base station apparatus 100-1 as its primary base station, and also notify the base station apparatus 100-1 that it is a terminal apparatus corresponding to IDLE mode measurement. Upon receiving this notification, the base station apparatus 100-1 can grasp that the base station apparatus 100-1 is the primary base station and serves as the base station that performs a control to cause the terminal apparatus 200 to perform data communication selectively using a plurality of cells. The information indicating that the base station apparatus 100-1 is the primary base station and the flag information may be included in the AS message requesting the connection at the step S101.

When the connection between the terminal apparatus 200 and the base station apparatus 100-1 is established, a NAS message for a registration is transmitted from the terminal apparatus 200 to the core network 10 via the base station apparatus 100-1 (step S104). When the terminal apparatus 200 is registered in the core network 10, a NAS message indicating that the registration has been accepted is transmitted from the core network 10 to the terminal apparatus 200 via the base station apparatus 100-1 (step S105).

The base station apparatus 100-1, which has grasped that the base station apparatus 100-1 is the primary base station, then requests the terminal apparatus 200 to report a measurement result of the signal strength by IDLE mode measurement (step S301). Upon receiving this request, the terminal apparatus 200 reports the measurement result of the signal strength measured during the RRC idle mode to the base station apparatus 100-1 (step S302). This measurement result of the signal strength includes measured results of signal strengths obtained from base station apparatuses surrounding the terminal apparatus 200, including the base station apparatus 100-2.

The base station apparatus 100-1 selects a secondary base station that can be a communication counterpart of the terminal apparatus 200 with the next highest priority after the base station apparatus 100-1 according to the measurement result of the signal strength. Specifically, the base station apparatus 100-1 selects the base station apparatus whose signal strength at the terminal apparatus 200 is equal to or more than a predetermined threshold as the secondary base station. Here, the base station apparatus 100-2 is selected as the secondary base station. After selecting the secondary base station, the base station apparatus 100-1 requests the base station apparatus 100-2 serving as the secondary base station to generate a UE context to be assigned to the terminal apparatus 200 (step S303). Upon receiving this request, the base station apparatus 100-2 generates the UE context for the terminal apparatus 200 and notifies the base station apparatus 100-1 of identification information on the generated UE context (step S304).

On the other hand, the base station apparatus 100-1 generates a UE context related to the terminal apparatus 200. Temporary identification information including the identification information of the terminal apparatus 200 and the identification information of the base station apparatus 100-1 is then generated as identification information on the UE context. As this temporary identification information, for example, I-RNTI can be used. Since the I-RNTI is 40 bits of identification information, the number of identifiable terminal apparatuses decreases while the number of identifiable base station apparatuses increases when the number of bits assigned to the identification information of the base station apparatus is increased. In addition, the number of identifiable terminal apparatuses increases while the number of identifiable base station apparatuses decreases when the number of bits assigned to the identification information of the base station apparatus is decreased. As identification information on the UE context, any information that enables identification on the UE context can be used in addition to the I-RNTI.

The base station apparatus 100-1 holds the generated UE context and notifies the terminal apparatus 200 of the identification information on the UE context, for example, by an AS message to release the connection (step S305). At this time, the terminal apparatus 200 is notified of the identification information on the UE context generated by the base station apparatus 100-1 together with the identification information on the UE context notified by the base station apparatus 100-2. In other words, the terminal apparatus 200 is collectively notified of the identification information on the UE context generated in relation to the terminal apparatus 200 by each of the base station apparatuses 100-1 and 100-2. Upon receiving this notification, the terminal apparatus 200 holds the identification information on the UE context and releases the connection with the base station apparatus 100-1. Accordingly, the terminal apparatus 200 transitions to the non-communication mode, such as RRC inactive mode, for example.

In this way, during the non-communication mode, the terminal apparatus 200 selects the primary base station according to the signal strength and requests the connection, and the primary base station selects the secondary base station after acquiring the measurement result of the signal strength from the terminal apparatus 200. The primary base station then acquires the identification information on the UE context from the secondary base station and notifies the terminal apparatus 200 of the identification information on the UE context generated by each of the primary and secondary base stations. Therefore, the terminal apparatus 200 can selectively perform data communication with the base stations even during the non-communication mode. For example, when the data communication with the primary base station fails, the terminal apparatus 200 can perform the data communication with the secondary base station. In other words, similar to the second embodiment (FIGS. 5 and 6), when the small data transmission from the terminal apparatus 200 to the base station apparatus 100-1 fails, the terminal apparatus 200 switches the communication counterpart to the base station apparatus 100-2 after the expiration of the predetermined timer and transmits the small data to the base station apparatus 100-2. Accordingly, the terminal apparatus 200 can continuously perform data communication during the non-communication mode.

As described above, according to the present embodiment, when the terminal apparatus selects the primary base station during the non-communication mode, the primary base station selects the secondary base station, and notifies the terminal apparatus of the identification information on the UE contexts generated by the primary and secondary base stations. When transmitting data during the non-communication mode, the terminal apparatus selectively transmits the data to the primary and secondary base stations. Therefore, even though the data transmission to the primary base station fails, the terminal apparatus can transmit the data to the secondary base station, and continuous data communication can be performed during the non-communication mode.

In each of the above embodiments, although it has been described that the primary base station with the first priority and the secondary base station with the second priority are selected, base stations with the third priority and onwards may be selected. In other words, for example, in the second embodiment, the terminal apparatus 200 may select three or more base station apparatuses that can be communication counterparts, transmits an AS message requesting connection to each of the base station apparatuses, and receives the notification of identification information on a UE context from each of the base station apparatuses.

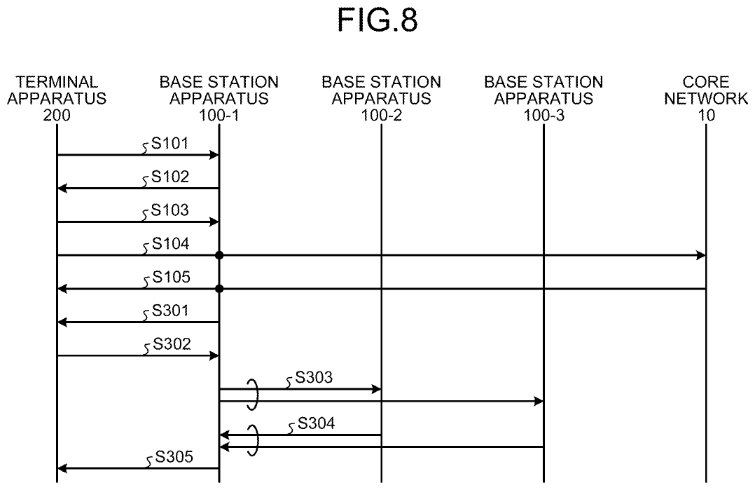

In addition, for example, in the third embodiment, the base station apparatuses 100-1 to 100-3 maybe selected as base station apparatuses that can be communication counterparts as illustrated in FIG. 8. As illustrated in FIG. 8, when the base station apparatus 100-1 serving as the primary base station selects the base station apparatus 100-2 with the second priority and the base station apparatus 100-3 with the third priority according to the signal strength at the terminal apparatus 200, the base station apparatus 100-1 requests these base stations to generate a UE context to be assigned to the terminal apparatus 200 (step S303). Upon receiving this request, each of the base station apparatuses 100-2 and 100-3 generates a UE context and notifies the base station apparatus 100-1 of identification information on the generated UE context (step S304).

In this way, since the three or more base station apparatuses that can be communication counterparts are selected, the terminal apparatus 200 can perform data communication with base station apparatuses with the third priority and onwards even though data communication fails with the base station apparatuses with the first and second priorities during the non-communication mode. As a result, the continuous data communication can be achieved during the non-communication mode.

In each of the above embodiments, when the data communication during the non-communication mode fails, the terminal apparatus 200 switches the base station serving as the communication counterpart after the expiration of the predetermined timer. As this predetermined timer, for example, a T319 timer can be used. In addition, when the data communication fails, the base station serving as the communication counterpart may be switched earlier using a timer that is configured to a shorter time than the T319 timer is.

Furthermore, the terminal apparatus 200 may switch the base station serving as a communication partner upon the fact that the number of failed data communication attempts reaches a predetermined number instead of the fact that the predetermined timer expires. In other words, for example, when the small data transmission to the primary base station fails a predetermined number of times, the terminal apparatus 200 may switch the communication counterpart to the secondary base station to transmit small data. These conditions are configured in the terminal apparatus 200 under control from the primary base station.

In addition, in each of the above embodiments, although it has been described that the communication counterpart of the terminal apparatus 200 is switched when the data communication fails, each of the above embodiments can also be applied to a case in which the terminal apparatus 200 moves between cells. In other words, for example, in a case in which the terminal apparatus 200 moves from a primary base station cell to a secondary base station cell during the non-communication mode, the terminal apparatus 200 can employ the primary base station as the communication counterpart while staying in the primary base station cell and employ the secondary base station as the communication counterpart after moving to the secondary base station cell.

According to one aspect of the wireless communication apparatus, wireless communication system, and wireless communication method disclosed in the present application, the effect that continuous data communication can be achieved during the non-communication mode is exhibited.

All examples and conditional language recited herein are intended for pedagogical purposes of aiding the reader in understanding the disclosure and the concepts contributed by the inventors to further the art, and are not to be construed as limitations to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

What is claimed is:

1. A wireless communication apparatus comprising:
processor circuitry configured to control to perform data communication when communication is performed with another wireless communication apparatus, the data communication selectively using a multiple-cell group, the multiple-cell group being selected when communication with the other wireless communication apparatus in a non-communication mode is established and being able to perform data communication allowed even in the non-communication mode.

2. The wireless communication apparatus according to claim 1, wherein the processor circuitry is further configured to notify the other wireless communication apparatus of identification information that enables simultaneous identification on the wireless communication apparatus and the other wireless communication apparatus, when the wireless communication apparatus establishes communication with the other wireless communication apparatus in a non-communication mode.

3. The wireless communication apparatus according to claim 1, wherein the processor circuitry is further configured to acquire a measurement result of a received signal strength in the other wireless communication apparatus, determines a base station corresponding to the multiple-cell group according to the measurement result, and requests identification information to be assigned to the other wireless communication apparatus from the base station, when the wireless communication apparatus establishes communication with the other wireless communication apparatus in a non-communication mode.

4. A wireless communication apparatus comprising:
processor circuitry configured to control to perform data communication when communication is performed with another wireless communication apparatus, under control from the other wireless communication apparatus, the data communication selectively using a multiple-cell group, the multiple-cell group being selected when communication with the other wireless communication apparatus is established in a non-communication mode and being able to perform data communication allowed even in the non-communication mode.

5. The wireless communication apparatus according to claim 4, wherein the processor circuitry is notified of identification information that enables simultaneous identification on the wireless communication apparatus and the other wireless communication apparatus by the other wireless communication apparatus, when the wireless communication apparatus in a non- communication mode establishes communication with the other wireless communication apparatus.

6. The wireless communication apparatus according to claim 4, wherein the processor circuitry notifies the other wireless communication apparatus of information indicating that the other wireless communication apparatus is a base station able to be a communication counterpart of the wireless communication apparatus, when the wireless communication apparatus in a non-communication mode establishes communication with the other wireless communication apparatus.

7. The wireless communication apparatus according to claim 4, wherein when data communication using a first cell included in the multiple-cell group fails, the processor circuitry performs data communication using a second cell included in the multiple-cell group.

8. A wireless communication system comprising:
a first wireless communication apparatus; and
a second wireless communication apparatus, wherein
the first wireless communication apparatus is further configured to control to perform data communication when communication is carried out with the second wireless communication apparatus, the data communication selectively using a multiple-cell group, the multiple-cell group being selected when communication with the second wireless communication apparatus in a non-communication mode is established and being able to perform data communication allowed even in the non-communication mode, and
the second wireless communication apparatus is further configured to control to perform data communication when communication is implemented with the first wireless communication apparatus, under control from the first wireless communication apparatus, the data communication selectively using a multiple-cell group, the multiple-cell group being selected when communication with the first wireless communication apparatus is established in a non-communication mode and being able to perform data communication allowed even in the non-communication mode.
